(19) United States
(12) Patent Application Publication
(10) Pub. No.: US 2009/0036345 A1
(43) Pub. Date: Feb. 5, 2009

(54) Light-Duty Dishwashing Detergent Compositions

(75) Inventors: Angelina Lorraine Kulbick, Little Falls, NJ (US); Dilip Shanker Mathur, East Brunswick, NJ (US)

Correspondence Address: NORRIS, MCLAUGHLIN & MARCUS, 875 THIRD AVE, 18TH FLOOR, NEW YORK, NY, 10022, US

(73) Assignee: RECKITT BENCKISER INC., Parsippany, NJ (US)

(21) Appl. No.: 11/993,523

(22) PCT Filed: May 24, 2006
(86) PCT No.: PCT/GB2006/001891

§ 371 Date: Mar. 10, 2008

(30) Foreign Application Priority Data
Jun. 23, 2005 (GB) 0512796.4
Aug. 23, 2005 (GB) 0517227.5

(51) Int. Cl. C11D 3/20

(52) U.S. Cl. 510/235

(57) ABSTRACT

Disclosed are light duty liquid detergent compositions which are particularly useful in the manual cleaning of dishes and tableware, as well as being useful in the cleaning of other surfaces particularly hard surfaces. The compositions exhibit excellent and rapid dispersability into larger volumes of water and provide excellent cleaning performance.

The present invention generally relates to light duty detergent compositions which useful in the cleaning of hard surfaces. More particularly the compositions of the present invention are directed to light duty detergent compositions which are particularly useful in the manual cleaning of dishes and tableware, as well as being useful in the cleaning of other surfaces particularly hard surfaces.

Light duty dishwashing detergent compositions provide effective cleaning of dishes and table ware when manually washed typically in a kitchen sink by a consumer. These light duty dishwashing detergent compositions may come in a variety of forms and dilutions and typically may be provided either as free flowing viscous liquids which may have viscosities ranging from water thin through more viscous but pourable mixtures, as well as in the form of gels or paste which may be distributed either from a squeezable container or a tub or other suitable container by a consumer. Preferably these light duty dishwashing detergent compositions are readily disbursable in the water and are particularly effective in cutting grease and hydrophobic stains such as fats, coagulated fats and other food deposits which may be present on the dishes and or tableware. Such light duty dishwashing detergent compositions frequently also find use in other areas as well including but not limited to: hard surface cleaning compositions, and laundry pre-spotter compositions. Additionally such light duty dishwashing compositions are not unknown for use as hand wash detergent soap and/or for use as cleaning compositions for fibrous substrates such as carpets, rugs, mats, and the like.

Commercially successful dishwashing detergent compositions usually necessarily exhibit one or more of the following properties: ready the dispersability into a larger volume of water, good cleaning of soiled surfaces, and, good foam height and/or duration. Dealing with the later first, most consumer expectations regarding the cleaning efficacy and light duty dishwashing detergent compositions relies upon the perceptions of good cleaning which in turn which is often directly attributed to the visible presence of foam upon the upper surface of water or wash bath within which the light duty dishwashing detergent compositions is disbursed. While there is actually very little relationship as to the cleaning efficacy of an aqueous dispersion of a light duty dishwashing detergent composition and its visible foam, consumer perceptions and consumer prejudices are very hard to overcome and thus the commercially successful light duty dishwashing detergent composition exhibit both good foam, height as well as good foam duration during both the initial mixing of the light duty dishwashing detergent compositions into a body of water i.e. such as maybe found in a sink or basin, as well as good foam duration, i.e. the durability of the visible foam during the manual dishwashing operation. A second important attribute of a commercially successful light duty dishwashing detergent composition is as noted above namely in that effective cleaning of soiled surfaces particularly hydrophobic soils need be achieved by a consumer. Ineffective cleaning, in particular ineffective solubilization of soils particularly hydrophobic soils, may lead to dissatisfaction with the use of such commercial product by the consumer. Finally, foam height is also particularly effective and provides a measure of the perceived cleaning benefits be provided by the light duty dishwashing detergent composition. Foam height, as well as the density of the foam, often provides an indication as to the cleaning efficacy as well as the useful service life of an aqueous dispersion of the light duty dishwashing detergent in water. The more substantive the foam, and/or the more pronounced the height of the foam floating upon the surface of the water, the higher consumer expectations of good cleaning efficacy. The third important attribute is the ready dispersability or dissolution of the composition into a larger volume of water. It is particularly advantageous that light duty dishwashing compositions quickly disperse or dissolve into a larger volume of water, i.e., a sink or basis containing a volume of water an optionally soiled dishes or soiled tableware. Quick dissolution provides for rapid distribution of the surfactant and other constituents into the water and permits for speedier contact with the soiled surfaces of the dishes or tableware to be washed.

Such light duty dishwashing detergent compositions are per se known to the art and available in a wide variety of forms as noted above. Notwithstanding this fact, there yet remains a continuing need in the art for further improvements to light duty dishwashing detergent compositions which are particularly useful in cleaning of dishes and table ware, as well as the cleaning of other surfaces as outlined above and later outlined herein. There is a particular need in the art for still further improvements to light duty dishwashing detergent compositions which provide improved performance over other known art compositions.

It is to these objects and yet further objects that the present invention is directed.

In one aspect the present invention provides a light duty dishwashing detergent composition which comprises:
an anionic surfactant constituent which includes necessarily at least one of each: a alkyl ether sulfate surfactant or salt form thereof in conjunction with an alkyl sulfate or salt form thereof;
a surfactant constituent based on a polysaccharide, preferably one or more alkyl polyglycosides;
optionally but in many cases desirably a betaine surfactant constituent;
optionally but preferably one or more non-ionic surfactants particularly one or more alcohol ethoxylates;
optionally but preferably an organic solvent constituent;
optionally but where necessary, an acid constituent;
optionally one or more further constituents which are directed to improving the aesthetic or functional features of the inventive compositions; and,
water,
such that the final compositions are in the pH range of pH 5-7.5 and further wherein, the total amount of the non-aqueous constituents present in the composition comprise at least 40% by weight of the total weight of the light duty dishwashing detergent composition.

The foregoing formulations may also include one or more optional constituents such as preservatives, colorants, fragrances, thickeners, further organic solvents, for the surfactants, pH buffers, pH adjusting agents, and the like in the minor amounts which are none the less sufficient to improve one or more of the technical characteristics and/or one or more of the consumer attributes of the compositions.

The foregoing compositions are provided either in the form of a pourable viscous liquid, or may be in the form of a paste or gel.

In preferred embodiments, the foregoing compositions are readily dispersible in water, especially when provided as a liquid composition.

In further preferred compositions, the inventive compositions exhibit good foam height/or a durable visible foam.

In certain preferred embodiments, the foregoing compositions are also generally mild to the skin and hands of the consumer utilizing the light duty dishwashing detergent composition.

In a still further embodiment of the invention, the light duty dishwashing detergent composition is used in a process for the manual cleaning of dishes and/or table ware particularly in the cleaning from food stains. The food stains may be dried, or baked on food stains, or may yet be moist. The compositions of the invention may be used in the formation of a dishwashing liquor or bath for the presoaking treatment, as well as for the manual washing of dishes and tableware.

The compositions of the invention necessarily include an anionic surfactant constituent which includes at least one of each: an alkyl ether sulfate surfactant or salt form thereof in conjunction with an alkyl sulfate or salt form thereof, and may optionally include one more further anionic surfactants.

Examples of anionic surfactants which may be used in the an anionic surfactant constituent include alcohol sulfates and sulfonates, alcohol phosphates and phosphonates, alkyl ester sulfates, alkyl diphenyl ether sulfonates, alkyl sulfates, alkyl ether sulfates, sulfate esters of an alkylphenoxy polyoxyethylene ethanol, alkyl monoglyceride sulfates, alkyl sulfonates, alkyl ether sulfates, alpha-olefin sulfonates, beta-alkoxy alkane sulfonates, alkyl ether sulfonates, ethoxylated alkyl sulfonates, alkylaryl sulfonates, alkylaryl sulfates, alkyl monoglyceride sulfonates, alkyl carboxylates, alkyl ether carboxylates, alkyl alkoxy carboxylates having 1 to 5 moles of ethylene oxide, alkylpolyglycolethersulfates (containing up to 10 moles of ethylene oxide), sulfosuccinates, octoxynol or nonoxynol phosphates, taurates, fatty taurides, fatty acid amide polyoxyethylene sulfates, acyl glycerol sulfonates, fatty oleyl glycerol sulfates, alkyl phenol ethylene oxide ether sulfates, paraffin sulfonates, alkyl phosphates, isethionates, N-acyl taurates, alkyl succinamates and sulfosuccinates, alkylpolysaccharide sulfates, alkylpolyglucoside sulfates, alkyl polyethoxy carboxylates, and sarcosinates or mixtures thereof. These anionic surfactants may be provided as salts with one or more organic counterions, e.g, ammonium, or inorganic counteraions, especially as salts of one or more alkaline earth or alkaline earth metals, e.g, sodium.

Further examples of anionic surfactants include water soluble salts or acids of the formula (ROSO₃)ₓM or (RSO₃)ₓM wherein R is preferably a C₆-C₂₄ hydrocarbyl, preferably an alkyl or hydroxyalkyl having a C₁₀-C₂₀ alkyl component, more preferably a C₁₂-C₁₈ alkyl or hydroxyalkyl, and M is H or a mono-, di- or tri-valent cation, e.g., an alkali metal cation (e.g., sodium, potassium, lithium), or ammonium or substituted ammonium (e.g., methyl-, dimethyl-, and trimethyl ammonium cations and quaternary ammonium cations, such as tetramethyl-ammonium and dimethyl piperidinium cations and quaternary ammonium cations derived from alkylamines such as ethylamine, diethylamine, triethylamine, and mixtures thereof, and the like) and x is an integer, preferably 1 to 3, most preferably 1. Materials sold under the Hostapur and Biosoft trademarks are examples of such anionic surfactants.

Still further examples of anionic surfactants include alkyl-diphenyl-ethersulphonates and alkyl-carboxylates. Other anionic surfactants can include salts (including, for example, sodium, potassium, ammonium, and substituted ammonium salts such as mono-, di- and triethanolamine salts) of soap, C₆-C₂₀ linear alkylbenzenesulfonates, C₆-C₂₂ primary or secondary alkanesulfonates, C₆-C₂₄ olefinsulfonates, sulfonated polycarboxylic acids prepared by sulfonation of the pyrolyzed product of alkaline earth metal citrates, C₆-C₂₄ alkylpolyglycolethersulfates, alkyl ester sulfates such as C₁₄₋₁₆ methyl ester sulfates; acyl glycerol sulfonates, fatty oleyl glycerol sulfates, alkyl phenol ethylene oxide ether sulfates, paraffin sulfonates, alkyl phosphates, isethionates such as the acyl isethionates, N-acyl taurates, alkyl succinamates and sulfosuccinates, monoesters of sulfosuccinate (especially saturated and unsaturated C₁₂-C₁₈ monoesters) diesters of sulfosuccinate (especially saturated and unsaturated C₆-C₁₄ diesters), acyl sarcosinates, sulfates of alkylpolysaccharides such as the sulfates of alkylpolyglucoside, branched primary alkyl sulfates, alkyl polyethoxy carboxylates such as those of the formula RO(CH₂CH₂O)ₖCH₂COO⁻M⁺ wherein R is a C₈-C₂₂ alkyl, k is an integer from 0 to 10, and M is a soluble salt-forming cation. Examples of the foregoing anionic surfactants are available under the following tradenames: RHODAPON, STEPANOL, HOSTAPUR, SURFINE, SANDOPAN, NEODOX, BIOSOFT, and AVANEL.

Desirably the anionic surfactants present in the inventive compositions comprise anionic surfactants which necessarily provide good foaming when used, and which is not undesirably irritating to the skin when used in the manual washing of dishwashing, tableware or other hard surfaces. By way of non-limiting example suitable foaming anionic surfactants include, but are not limited to: alkyl sulfates especially alkyl ether sulfates, alpha-olefin sulfonates, and mixtures thereof, particularly C₁₂-C₁₆ olefin sulfonates such as sodium lauryl sulfate and ammonium lauryl sulfate. Such foaming anionic surfactants, particularly the preferred C₁₂-C₁₆ olefin sulfonates provide high foaming with substantive foam duration to the inventive compositions.

Preferably at least one C₁₂-C₁₆ olefin sulfonate, which is preferably present as a salt such as a sodium or ammonium salt, and particularly preferably a lauryl sulfate or an ammonium lauryl sulfate, is present in conjunction with at least one C₁₂-C₁₆ ether sulfate, which is preferably present as a salt such as a sodium or ammonium salt, and particularly preferably a sodium lauryl ether sulfate, but more preferably both are necessarily present in the anionic surfactant constituent.

Preferably, the compositions of the invention excludes sulfonate based surfactants in the anionic surfactant constituent, as while providing good cleaning and good foaming, these sulfonate based anionic surfactants or salt forms thereof are more irritating to the skins, hands and/or general tissue than other anionic surfactants, in particular the alkyl ether sulfates and the alkyl sulfates which are preferred for use in the inventive composition.

The one or more anionic surfactants are present in amounts of from 0.1-15% wt., preferably in amounts from 0.5-15% wt., but are most desirably present in reduced weight percentages from about 1-12% wt. based on the total weight of the topical composition of which they form a part.

The present inventors have surprisingly found that in accordance with certain preferred embodiments, improved performance characteristics can be achieved when particular proportions of the alkyl ether sulfate, and alkyl sulfate surfactants are maintained. Namely, accordingly to certain preferred embodiment of the invention, the respective weight ratio of alkyl ether sulfate or salt form thereof to alkyl sulfate or salt form thereof is in the range of at least 1.1:1 to about 20:1. More preferred embodiments of the invention are wherein this proportion is actually at the lower end of this foregoing range and namely, wherein the weight ratio of alkyl ether sulfate to alkyl sulfate is typically in the range of 1.1:1 to 5:1, and yet more preferably in the range from 1.5:1 to 4:1. In particularly preferred embodiments, the ratio, by weight percent, of alkyl ether sulfate to alkyl sulfate is in a tightly circumscribed respective weight ration range of from about 1.75:1 to 3.6:1. These restrictions, as further in conjunction with the preferred ranges of weight percent of the anionic surfactant constituent has been surprisingly discovered by the inventors to provide an excellent foaming benefit and concurrently, excellent cleaning benefit of the light duty dishwashing detergent composition described therein. According to certain particularly preferred embodiments the alkyl ether sulfate or salt form thereof to alkyl sulfate or salt form thereof are one or more of the anionic surfactants identified in the examples.

The inventive compositions further necessarily require a surfactant based on a polysaccharide, which are preferably one or more alkyl polyglycosides. Suitable alkyl polyglycosides are known nonionic surfactants which are alkaline and electrolyte stable. Such include alkyl glucosides, alkyl polyglucosides and mixtures thereof. Alkyl glucosides and alkyl polyglucosides can be broadly defined as condensation articles of long chain alcohols, e.g., C₈-C₃₀ alcohols, with sugars or starches or sugar or starch polymers i.e., glycosides or polyglycosides. These compounds can be represented by the formula (S)ₙ—O—R wherein S is a sugar moiety such as glucose, fructose, mannose, and galactose; n is an integer of from about 1 to about 1000, and R is a C₈₋₃₀ alkyl group. Examples of long chain alcohols from which the alkyl group can be derived include decyl alcohol, cetyl alcohol, stearyl alcohol, lauryl alcohol, myristyl alcohol, oleyl alcohol and the like.

Alkyl mono and polyglycosides are prepared generally by reacting a monosaccharide, or a compound hydrolyzable to a monosaccharide with an alcohol such as a fatty alcohol in an acid medium. Various glycoside and polyglycoside compounds including alkoxylated glycosides and processes for making them are disclosed in U.S. Pat. No. 2,974,134; U.S. Pat. No. 3,219,656; U.S. Pat. No. 3,598,865; U.S. Pat. No. 3,640,998; U.S. Pat. No. 3,707,535; U.S. Pat. No. 3,772,269; U.S. Pat. No. 3,839,318; U.S. Pat. No. 3,974,138; U.S. Pat. No. 4,223,129; and U.S. Pat. No. 4,528,106.

A preferred group of alkyl glycoside surfactants suitable for use in the practice of this invention may be represented by formula I below:

RO—(R₁O)_{y}-(G)ₓZ_{b} I

wherein:
R is a monovalent organic radical containing from about 6 to about 30, preferably from about 8 to about 18 carbon atoms;
R₁ is a divalent hydrocarbon radical containing from about 2 to about 4 carbon atoms;
O is an oxygen atom;
y is a number which has an average value from about 0 to about 1 and is preferably 0;
G is a moiety derived from a reducing saccharide containing 5 or 6 carbon atoms; and
x is a number having an average value from about 1 to 5 (preferably from 1.1 to 2);
Z is O₂M¹,

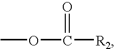

O(CH₂), CO₂M¹, OSO₃M¹, or O(CH₂)SO₃M¹; R₂ is (CH₂)CO₂M¹ or CH═CHCO₂M¹; (with the proviso that Z can be O₂M only if Z is in place of a primary hydroxyl group in which the primary hydroxyl-bearing carbon atom, —CH₂OH, is oxidized to form a

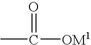

group);
b is a number of from 0 to 3x+1 preferably an average of from 0.5 to 2 per glycosal group;
p is 1 to 10,
M¹ is H⁺ or an organic or inorganic cation, such as, for example, an alkali metal, ammonium, monoethanolamine, or calcium.

As defined in Formula I above, R is generally the residue of a fatty alcohol having from about 8 to 30 and preferably 8 to 18 carbon atoms. Examples of such alkylglycosides as described above include, for example, APG™ 325 CS which is described as being a 50% C₉-C₁₁ alkyl polyglycoside, also commonly referred to as D-glucopyranoside, (ex. Henkel Corp) and Glucopon® 625 CS which is described as being a 50% C₁₀-C₁₆ alkyl polyglycoside, also commonly referred to as a D-glucopyranoside, (ex. Henkel Corp.), and lauryl polyglucoside available as APG 600 CS and 625 CS (ex. Henkel Corp.) as well as other materials sold under the Glucopon® tradename, especially one or more of the alkyl polyglycosides demonstrated in one or more of the examples.

The present inventors have also found that a still further ratio of certain of the surfactant constituents plays a role in defining preferred embodiment of the invention which provides surprisingly improved performance characteristics over prior art formulations. Namely, present inventors have discovered that the proportion of the total amount of the anionic surfactant constituent, in particularly the sum total amount of the weight percent of the alkyl ether sulfate or salt form thereof and the alkyl sulfate or salt form thereof surfactants with respect to the total amount of the alkyl polyglycosides should desirably also be maintained within particular weight ratios in order to provide excellent technical performance. More specifically, the weight ratio of the total amount of the anionic surfactant constituent to the total amount of the alkyl polyglycosides in percent by weight should be maintained in the proportion of at least 1.35:1, and more preferably these respective weight ratios are maintained in the range of about 2:1 to 5:1., yet more preferably from about 2.5:1 to 4.75:1. Preferably, this weight ratio between the anionic surfactant constituent and the alkyl polyglycosides are maintained in preferred embodiments as excellent and durable foams heights can be achieved initially upon mixing or dispersion of the light duty dishwashing detergent composition water, as well as maintaining a substantive foam during the use of the aqueous dispersed dishwashing detergent composition used during a cleaning operation.

According to many preferred embodiments, the inventive compositions include one or more nonionic surfactants and virtually all known art nonionic surfactants may be used in the present inventive compositions. Illustrative examples of suitable nonionic surfactants include, inter alia, condensation products of alkylene oxide groups with an organic hydrophobic compound, such as an aliphatic compound or with an alkyl aromatic compound. The nonionic synthetic organic detergents generally are the condensation products of an organic aliphatic or alkyl aromatic hydrophobic compound and hydrophilic ethylene oxide groups. Practically any hydrophobic compound having a carboxy, hydroxy, amido, or amino group with a free hydrogen attached to the nitrogen can be condensed with ethylene oxide or with the polyhydration product thereof, polyethylene glycol, to form a water soluble nonionic detergent. Further, the length of the polyethenoxy hydrophobic and hydrophilic elements may be varied to adjust these properties. Illustrative examples of such a nonionic surfactants include the condensation product of one mole of an alkyl phenol having an alkyl group containing from 6 to 12 carbon atoms with from about 5 to 25 moles of an alkylene oxide. Another example of such a nonionic surfactant is the condensation product of one mole of an aliphatic alcohol which may be a primary, secondary or tertiary alcohol having from 6 to 18 carbon atoms with from 1 to about 10 moles of alkylene oxide. Preferred alkylene oxides are ethylene oxides or propylene oxides which may be present singly, or may be both present.

Still further illustrative examples of nonionic surfactants include primary and secondary linear and branched alcohol ethoxylates, such as those based on C₆-C₁₈ alcohols which further include an average of from 2 to 80 moles of ethoxylation per mol of alcohol. Examples include the Genapol® series of linear alcohol ethoxylates from Clariant Corp., Charlotte, N.C. The 26-L series is based on the formula RO(CH₂CH₂O)ₙH wherein R is a mixture of linear, even carbon-number hydrocarbon chains ranging from C₁₂H₂₅ to C₁₆H₃₃ and n represents the number of repeating units and is a number of from 1 to about 12, such as 26-L-1,26-L-1,6,26-L-2,26-L-3, 26-L-5,26-L-45, 26-L-50, 26-L-60, 26-L-60N, 26-L-75, 26-L-80, 26-L-98N, and the 24-L series, derived from synthetic sources and typically contain about 55% C₁₂ and 45% C₁₋₄ alcohols, such as 24-L-3,24-L-45, 24-L-50, 24-L-60, 24-L-60N, 24-L-75, 24-L-92, and 24-L-98N. From product literature, the single number following the “L” corresponds to the average degree of ethoxylation (numbers between 1 and 5) and the two digit number following the letter “L” corresponds to the cloud point in ° C. of a 1.0 wt. % solution in water.

Further examples of useful nonionic surfactants include secondary C₁₂-C₁₅ alcohol ethoxylates, including those which have from about 3 to about 10 moles of ethoxylation. Such are available in the Tergitol® series of nonionic surfactants (Dow Chemical, Midland, Mich.), particularly those in the Tergitol® “15-S-” series. Further exemplary nonionic surfactants include linear primary C₁₁-C₁₅ alcohol ethoxylates, including those which have from about 3 to about 10 moles of ethoxylation. Such are available in the Tomadol® series of nonionic surfactants under the following tradenames: Tomadol 1-3 (linear C₁₁ alcohol with 3 moles (average) of ethylene oxide); Tomadol 1-5 (linear C₁₁ alcohol with 5 moles (average) of ethylene oxide); Tomadol 1-7 (linear C₁₁ alcohol with 7 moles (average) of ethylene oxide); Tomadol 1-9 (linear C₁₁ alcohol with 9 moles (average) of ethylene oxide); Tomadol 23-1 (linear C₁₂₋₁₃ alcohol with 1 mole (average) of ethylene oxide); Tomadol 23-3 (linear C₁₂₋₁₃ alcohol with 3 moles (average) of ethylene oxide); Tomadol 23-5 (linear C₁₂₋₁₃ alcohol with 5 moles (average) of ethylene oxide); Tomadol 23-6.5 (linear C₁₂₋₁₃ alcohol with 6.6 moles (average) of ethylene oxide); Tomadol 25-12 (linear C₁₂₋₁₅ alcohol with 11.9 moles (average) of ethylene oxide); Tomadol 25-3 (linear C₁₂₋₁₅ alcohol with 2.8 moles (average) of ethylene oxide); Tomadol 25-7 (linear C₁₂₋₁₅ alcohol with 7.3 moles (average) of ethylene oxide); Tomadol 25-9 (linear C₁₂₋₁₅ alcohol with 8.9 moles (average) of ethylene oxide); Tomadol 45-13 (linear C₁₄₋₁₅ alcohol with 12.9 moles (average) of ethylene oxide); Tomadol 45-2.25 (linear C₁₄₋₁₅ alcohol with 2.23 moles (average) of ethylene oxide); Tomadol 45-7 (linear C₁₄₋₁₅ alcohol with 7 moles (average) of ethylene oxide); Tomadol 91-2.5 (linear C₉₋₁₁ alcohol with 2.7 moles (average) of ethylene oxide); Tomadol 91-6 (linear C₉₋₁₁ alcohol with 6 moles (average) of ethylene oxide); Tomadol 91-8 (linear C₉₋₁₁ alcohol with 8.3 moles (average) of ethylene oxide) (Tomah Products, Inc., Milton, Wis.).

Further examples of useful nonionic surfactants include C₆-C₁₅ straight chain alcohols ethoxylated with about 1 to 13 moles of ethylene oxide, particularly those which include about 4 to about 7 moles of ethylene oxide. Examples of such nonionic surfactants include Alfonic® 810-4.5, which is described as having an average molecular weight of 356, an ethylene oxide content of about 4.85 moles and an HLB of about 12; Alfonic® 810-2, which is described as having an average molecular weight of 242, an ethylene oxide content of about 2.1 moles and an HLB of about 12; and Alfonic® 610-3.5, which is described as having an average molecular weight of 276, an ethylene oxide content of about 3.1 moles, and an HLB of 10.

Nonionic surfactants sold under the Neodol® tradename may also be used and in many cases are analogous to or the same as one or more of the foregoing described nonionic surfactants.

A further class of exemplary useful nonionic surfactants which may find use in the present inventive compositions include ethoxylated octyl and nonyl phenols include those having one of the following general structural formulas:

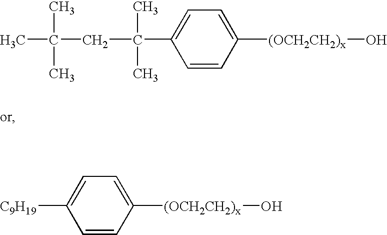

in which the C₉H₁₉ group in the latter formula is a mixture of branched chained isomers, and x indicates an average number of ethoxy units in the side chain. Particularly suitable non-ionic ethoxylated octyl and nonyl phenols include those having from about 7 to about 13 ethoxy groups. Such compounds are commercially available under the trade name Triton® X (Dow Chemical, Midland, Mich.), as well as under the tradename Igepal® (Rhodia, Princeton, N.J.). One exemplary and particularly preferred nonylphenol ethoxylate is Igepal® CO-630.

Still further examples of suitable nonionic surfactants for use as the (b) at least one nonionic surfactant include which may be advantageously included in the inventive compositions are alkoxy block copolymers, and in particular, compounds based on ethoxy/propoxy block copolymers. Polymeric alkylene oxide block copolymers include nonionic surfactants in which the major portion of the molecule is made up of block polymeric C₂-C₄ alkylene oxides. Such nonionic surfactants, while preferably built up from an alkylene oxide chain starting group, and can have as a starting nucleus almost any active hydrogen containing group including, without limitation, amides, phenols, thiols and secondary alcohols.

One group of such useful nonionic surfactants containing the characteristic alkylene oxide blocks are those which may be generally represented by the formula (A):

HO-(EO)ₓ(PO)_{y}(EO)_{z}—H (A)

where
EO represents ethylene oxide,
PO represents propylene oxide,
y equals at least 15,
(EO)_{x+z} equals 20 to 50% of the total weight of said compounds, and, the total molecular weight is preferably in the range of about 2000 to 15,000.

Another group of nonionic surfactants for use in the new compositions can be represented by the formula (B):

R-(EO,PO)ₐ(EO,PO)_{b}—H (B)

wherein R is an alkyl, aryl or aralkyl group, where the R group contains 1 to 20 carbon atoms, the weight percent of EO is within the range of 0 to 45% in one of the blocks a, b, and within the range of 60 to 100% in the other of the blocks a, b, and the total number of moles of combined EO and PO is in the range of 6 to 125 moles, with 1 to 50 moles in the PO rich block and 5 to 100 moles in the EO rich block.

Further nonionic surfactants which in general are encompassed by Formula B include butoxy derivatives of propylene oxide/ethylene oxide block polymers having molecular weights within the range of about 2000-5000.

Still further useful nonionic surfactants containing polymeric butoxy (BO) groups can be represented by formula (C) as follows:

RO—(BO)ₙ(EO)ₓ—H (C)

wherein
R is an alkyl group containing 1 to 20 carbon atoms,
n is about 5-15 and x is about 5-15.

Also useful as the nonionic block copolymer surfactants, which also include polymeric butoxy groups, are those which may be represented by the following formula (D):

HO-(EO)ₓ(BO)ₙ(EO)_{y}—H (D)

wherein
n is about 5-15, preferably about 15,
x is about 5-15, preferably about 15, and
y is about 5-15, preferably about 15.

Still further useful nonionic block copolymer surfactants include ethoxylated derivatives of propoxylated ethylene diamine, which may be represented by the following formula:

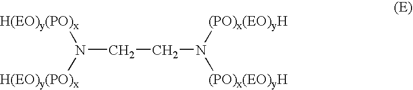

where
(EO) represents ethoxy,
(PO) represents propoxy,

the amount of (PO)ₓ is such as to provide a molecular weight prior to ethoxylation of about 300 to 7500, and the amount of (EO)_{y} is such as to provide about 20% to 90% of the total weight of said compound.

Particularly preferred nonionic surfactants are one or more based C₆-C₁₅ straight chain alcohols ethoxylated with about 1 to 13 moles of ethylene oxide, particularly those which include about 4 to about 7 moles of ethylene oxide and which are based on C₉-C₁₅ straight chain alcohols. Apart from the alkyl polyglycoside or other surfactant based on a saccharide which are also nonionic surfactants, in certain particularly preferred embodiments the sole further nonionic surfactant which may be present in the inventive compositions are one or more nonionic surfactants based C₆-C₁₅ straight chain alcohols ethoxylated with about 1 to 13 moles of ethylene oxide, particularly those which include about 4 to about 7 moles of ethylene oxide and which are based on C₉-C₁₅ straight chain alcohols.

When present one or more of the foregoing nonionic surfactants (apart from the alkyl polyglycoside or other surfactant based on a saccharide or polysaccharide) are included in the compositions of the present invention in an amount of from about 1 to about 10% by weight, desirably in amounts of about 2 to about 8% by weight, and most desirably from about 3 to about 5% weight, based on the total weight of the compositions of which they form a part. Particularly preferred nonionic surfactants and weight percentages thereof are described with reference to one or more of the Examples.

Betaines may be used in the inventive composition and provide the dual benefits of providing good foaming benefit as well as providing a useful pH buffering effect. The betaines retain good foaming characteristics as well as good cleaning characteristics even when there is a shift of pH in the wash water to beyond the range of pH 6-7 and even when less than, or greater than this pH range still provide effective foaming and cleaning. Such are particularly desirable to include in the inventive composition as the presence of the betaine allows for an insured cleaning of benefit notwithstanding deviations in the pH from an approximately neutral pH.

Exemplary useful betaine surfactants include those according to the general formula:

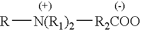

wherein R is a hydrophobic group selected from the group consisting of alkyl groups containing from about 10 to about 22 carbon atoms, preferably from about 12 to about 18 carbon atoms, alkyl aryl and aryl alkyl groups containing a similar number of carbon atoms with a benzene ring being treated as equivalent to about 2 carbon atoms, and similar structures interrupted by amido or ether linkages; each R₁ is an alkyl group containing from 1 to about 3 carbon atoms; and R₂ is an alkylene group containing from 1 to about 6 carbon atoms. Examples of preferred betaines are dodecyl dimethyl betaine, cetyl dimethyl betaine, dodecyl amidopropyldimethyl betaine, tetradecyldimethyl betaine, tetradecylamidopropyldimethyl betaine, and dodecyldimethylammonium hexanoate.

It is to be noted however that the amount of betaines should be carefully controlled in order to maintain a target viscosity for the light duty dishwashing detergent composition. With respect to the betaines, as most of these commercially supplied with a significant amount of sodium chloride salt in commercial preparations, the total amount of such commercial preparation containing both the buetaine and the sodium chloride salt should be carefully controlled and in certain instances limited. The inclusion of too much sodium chloride in the inventive composition may impart a viscosity thinning effect which is undesired particularly wherein a viscous form of the light duty dishwashing detergent or a gel or paste form of the light duty dishwashing detergent composition may be desired.

When present betaines are present in the compositions of the present invention in an amount of from about 1% to about 10% by weight, desirably in amounts of about 3 to about 9% by weight, and most desirably from about 4 to about 7% weight. Particularly preferred betaines and weight percentages thereof are described with reference to one or more of the Examples.

An optional but preferred additional constituent is an alkanolamide constituent which provides additional cleaning and which also functions as a foam booster which improves the foaming characteristics of the anionic surfactant(s) present. Such an alkanolamide constituent may also provide a thickening benefit to the inventive compositions of which they form a part. Such alkanolamides are based on one or more fatty acid amides which provide composition thickening, foam enhancement, and foam stability and in preferred embodiments of the invention are necessarily present.

Exemplary useful alkanolamides include one or more monoethanol amides, and diethanol amides of fatty acids having an acyl moiety which contains from about 8 to about 18 carbon atoms, and which may be represented in accordance with the formula:

R₁—CO—N(H)ₘ₋₁(R₂OH)₃₋ₘ

where R₁ represents a saturated or unsaturated aliphatic hydrocarbon radical of from about 7 to 21 carbon atoms, but preferably from about 11 to 17 carbon atoms; R₂ represents a —CH₂— or —CH₂CH₂—, and m is an integer from 1 to 3, but is preferably 1. Preferably, R₁ is a saturated or unsaturated aliphatic hydrocarbon radical comprising from about 11 to 17 carbon atoms, and m is 1. Specific examples of such compounds include mono-ethanol amine coconut fatty acid amide and diethanol amine dodecyl fatty acid amide. An exemplary useful and particularly preferred fatty acid amides include cocomonoethanol amide or cocodiethanolamide, which are presently commercially available as MONAMID CMA or MONAMID MDNA (ex. Mona Industries, Paterson N.J.). Further exemplary useful alkanolamides which provide such functions include inter alia: cocamide MEA, cocamide DEA, soyamide DEA, lauramide DEA, oleamide MIPA, stearamide MEA, myristamide MEA, lauramide MEA, capramide DEA, ricinoleamide DEA, myristamide DEA, stearamide DEA, oleylamide DEA, tallowamide DEA, lauramide MIPA, tallowamide MEA, isostearamide DEA, isostearamide MEA, and mixtures thereof. When present the alkanolamide constituent is present in the compositions of the present invention in an amount of from about 1 to about 10% by weight, desirably in amounts of about 2 to about 9% by weight, and most desirably from about 4 to about 7% weight. Particularly preferred alkanolamides and weight percentages thereof are described with reference to one or more of the Examples.

The inventive compositions may include an organic solvent constituent, and in certain preferred embodiments an organic solvent constituent is necessarily present. Exemplary useful organic solvents which may be present in the inventive compositions include those which are at least partially water-miscible such as alcohols (e.g., low molecular weight alcohols, such as, for example, ethanol, propanol, isopropanol, and the like), glycols (such as, for example, ethylene glycol, propylene glycol, hexylene glycol, and the like), water-miscible ethers (e.g. diethylene glycol diethylether, diethylene glycol dimethylether, propylene glycol dimethylether), water-miscible glycol ether (e.g. propylene glycol monomethylether, propylene glycol mono ethylether, propylene glycol monopropylether, propylene glycol monobutylether, ethylene glycol monobutylether, dipropylene glycol monomethylether, diethyleneglycol monobutylether), lower esters of monoalkylethers of ethylene glycol or propylene glycol (e.g. propylene glycol monomethyl ether acetate), and mixtures thereof. Glycol ethers having the general structure Ra—Rb—OH, wherein Ra is an alkoxy of 1 to 20 carbon atoms, or aryloxy of at least 6 carbon atoms, and Rb is an ether condensate of propylene glycol and/or ethylene glycol having from one to ten glycol monomer units. Mixtures of two or more specific organic solvents may be used, or alternately a single organic solvent may be provided as the organic solvent constituent.

Preferably, when present, the organic solvent constituent consists essentially of a water miscible glycol ether to the exclusion of other organic solvents. More preferably the organic solvent constituent consists solely of a water miscible alkylene glycol, especially propylene glycol.

When present the organic solvent is present in the compositions of the present invention in an amount of from about 1 to about 20% by weight, desirably in amounts of about 5 to about 15% by weight, and most desirably from about 7 to about 12% weight. Particularly preferred organic solvent constituents and weigh percentages thereof are described with reference to one or more of the Examples.

As noted, according to certain embodiments an organic solvent constituent is necessarily present, while in other preferred embodiments an organic solvent constituent is omitted. When an organic solid constituent is included its inclusion frequently provides for some reduction in the overall viscosity of the light duty dishwashing detergent composition which may be desirable in certain embodiments of the invention. Also, the inclusion of the organic solvent constituent provides a salvating component which may be effective in certain forms of stains to be treated and thus is often advantageously included. When included, the amount of the organic solvent constituent should be carefully controlled in order to provide the improved salvating benefit while at the same time not unduly thinning out or reducing the viscosity of the composition of which it forms as a part.

The compositions of the present invention can also optionally comprise one or more further constituents which are directed to improving the aesthetic or functional features of the inventive compositions. Such conventional additives known to the art include but not expressly enumerated here may also be included in the compositions according to the invention. By way of non-limiting example without limitation these may include: chelating agents, colorants, fragrances, thickening agents, hydrotropes, pH adjusting agents, pH buffers as well as one or more further detersive surfactants not noted previously. Many of these materials are known to the art, per se, and are described in McCutcheon's Detergents and Emulsifiers, North American Edition, 1998; Kirk-Othmer, Encyclopedia of Chemical Technology, 4th Ed., Vol. 23, pp. 478-541 (1997. Such optional, i.e., non-essential constituents should be selected so to have little or no detrimental effect upon the desirable characteristics of the present invention. When present, the one or more optional constituents present in the inventive compositions do not exceed about 10% wt., preferably do not exceed 8% wt., and most preferably do not exceed 5% wt. of the composition of which they form a part.

Advantageously included constituents are one or more coloring agents which find use in modifying the appearance of the compositions and enhance their appearance from the perspective of a consumer or other end user. Known coloring agents, such as water soluble or water dispersible dyestuffs or other colorants may be incorporated in the compositions in effective amounts.

The compositions of the invention optionally but in certain cases desirably include a fragrance constituent. Fragrance raw materials may be divided into three main groups: (1) the essential oils and products isolated from these oils; (2) products of animal origin; and (3) synthetic chemicals.

The essential oils consist of complex mixtures of volatile liquid and solid chemicals found in various parts of plants. Mention may be made of oils found in flowers, e.g., jasmine, rose, mimosa, and orange blossom; flowers and leaves, e.g., lavender and rosemary; leaves and stems, e.g., geranium, patchouli, and petitgrain; barks, e.g., cinnamon; woods, e.g., sandalwood and rosewood; roots, e.g., angelica; rhizomes, e.g., ginger; fruits, e.g., orange, lemon, and bergamot; seeds, e.g., aniseed and nutmeg; and resinous exudations, e.g., myrrh. These essential oils consist of a complex mixture of chemicals, the major portion thereof being terpenes, including hydrocarbons of the formula (C₅H₈)ₙ and their oxygenated derivatives. Hydrocarbons such as these give rise to a large number of oxygenated derivatives, e.g., alcohols and their esters, aldehydes and ketones. Some of the more important of these are geraniol, citronellol and terpineol, citral and citronellal, and camphor. Other constituents include aliphatic aldehydes and also aromatic compounds including phenols such as eugenol. In some instances, specific compounds may be isolated from the essential oils, usually by distillation in a commercially pure state, for example, geraniol and citronellal from citronella oil; citral from lemon-grass oil; eugenol from clove oil; linalool from rosewood oil; and safrole from sassafras oil. The natural isolates may also be chemically modified as in the case of citronellal to hydroxy citronellal, citral to ionone, eugenol to vanillin, linalool to linalyl acetate, and safrol to heliotropin.

Animal products used in perfumes include musk, ambergris, civet and castoreum, and are generally provided as alcoholic tinctures.

The synthetic chemicals include not only the synthetically made, also naturally occurring isolates mentioned above, but also include their derivatives and compounds unknown in nature, e.g., isoamylsalicylate, amylcinnamic aldehyde, cyclamen aldehyde, heliotropin, ionone, phenylethyl alcohol, terpineol, undecalactone, and gamma nonyl lactone.

Fragrance compositions as received from a supplier may be provided as an aqueous or organically solvated composition, and may include as a hydrotrope or emulsifier a surface-active agent, typically a surfactant, in minor amount. Such fragrance compositions are quite usually proprietary blends of many different specific fragrance compounds. However, one of ordinary skill in the art, by routine experimentation, may easily determine whether such a proprietary fragrance composition is compatible in the compositions of the present invention.

The topical compositions may include one or more preservatives. Exemplary useful preservatives include compositions which comprise parabens, including methyl parabens and ethyl parabens, glyoxals, glutaraldehyde, formaldehyde, 2-bromo-2-nitropropoane-1,3-diol, 5-chloro-2-methyl-4-isothiazolin-3-one, 2-methyl-4-isothiazoline-3-one, and mixtures thereof. One exemplary composition is a combination 5-chloro-2-methyl-4-isothiazolin-3-one and 2-methyl-4-isothiazolin-3-one where the amount of either component may be present in the mixture anywhere from 0.001 to 99.99 weight percent, based on the total amount of the preservative. For reasons of availability, the most preferred preservative are those commercially available preservative comprising a mixture of 5-chloro-2-methyl-4-isothiazolin-3-one and 2-methyl-4-isothiazolin-3-one marketed under the trademark KATHON CG/ICP as a preservative composition (ex. Rohm and Haas Inc.). Further useful preservative compositions include KATHON CG/ICP II (ex. Rohm and Haas Inc.), PROXEL (ex. Zeneca), SUTTOCIDE A (ex. Sutton Laboratories) as well as TEXTAMER 38AD (ex. Calgon Corp.) An exemplary preferred preservative composition based on isothiazoline compounds is ACTICIDE MBS (ex. Thor Group (UK), a division of Acti-Chem Specialties, Inc, Trumbull, Conn.) which includes both bensisothiazoline and methylisothiazoline. A further exemplary preferred preservative composition based on glyoxals includes ACTICIDE FN (ex. Thor Group (UK), described by its supplier as containing tetrahydroxymethylglyoxal diureaide. Particularly preferred preservative constituents and weigh percentages thereof are described with reference to one or more of the Examples.

When present the preservative is included in any amount found to be effective in retarding or inhibiting the grown of undesired microorganisms in the topical compositions, particularly during storage for several months at room temperature. When present in a composition, in accordance with certain of the preferred embodiments, the preservative composition is advantageously present in amounts of up to about 1.5% wt., preferably are present in amounts of from about 0.00001% wt. to about 0.5% wt., and most preferably is present in an amount of from about 0.0001% wt. to 0.1% wt. based on the total weight of the topical composition of which it forms a part.

The compositions of the invention may include a water soluble or water dispersible thickener constituent in order to increase the viscosity of the compositions. Thickeners useful in the present invention to achieve this viscosity are selected from the group consisting of polysaccharide polymers selected from cellulose, alkyl celluloses, alkoxy celluloses, hydroxy alkyl celluloses, alkyl hydroxy alkyl celluloses, carboxy alkyl celluloses, carboxy alkyl hydroxy alkyl celluloses, naturally occurring polysaccharide polymers such as xanthan gum, guar gum, locust bean gum, tragacanth gum, or derivatives thereof, polycarboxylate polymers, polyacrylamides, clays, and mixtures thereof.

Examples of the cellulose derivatives include methyl cellulose ethyl cellulose, hydroxymethyl cellulose hydroxy ethyl cellulose, hydroxy propyl cellulose, carboxy methyl cellulose, carboxy methyl hydroxyethyl cellulose, hydroxypropyl cellulose, hydroxy propyl methyl cellulose, ethylhydroxymethyl cellulose and ethyl hydroxy ethyl cellulose.

Examplary polycarboxylate polymers thickeners have a molecular weight from about 500,000 to about 4,000,000, preferably from about 1,000,000 to about 4,000,000, with, preferably, from about 0.5% to about 4% crosslinking. Preferred polycarboxylate polymers include polyacrylate polymers including those sold under trade names Carbopol®, Acrysol® ICS-1 and Sokalan®. The preferred polymers are polyacrylates. Other monomers besides acrylic acid can be used to form these polymers including such monomers as ethylene and propylene which act as diluents, and maleic anhydride which acts as a source of additional carboxylic groups.

The polycarboxylate polymer can be a non-associative thickener or stabilizer, such as a homopolymer or a copolymer of an olefinically unsaturated carboxylic acid or anhydride monomers containing at least one activated carbon to carbon olefinic double bond and at least one carboxyl group or an alkali soluble acrylic emulsion, or an associative thickener or stabilizer, such as a hydrophobically modified alkali soluble acrylic emulsion or a hydrophobically modified nonionic polyol polymer, i.e., a hydrophobically modified urethane polymer, or combinations thereof. The copolymers are preferably of a polycarboxylic acid monomer and a hydrophobic monomer. The preferred carboxylic acid is acrylic acid. The homopolymers and copolymers preferably are crosslinked.

Homopolymers of polyacrylic acid are described, for example, in U.S. Pat. No. 2,798,053. Examples of homopolymers which are useful include Carbopol® 934, 940, 941, Ultrez 10, ETD 2050, and 974P polymers, which are available from Noveon. Such polymers are homopolymers of unsaturated, polymerizable carboxylic monomers such as acrylic acid, methacrylic acid, maleic acid, itaconic acid, maleic anhydride, and the like.

Hydrophobically modified polyacrylic acid polymers are described, for example, in U.S. Pat. Nos. 3,915,921, 4,421,902, 4,509,949, 4,923,940, 4,996,274, 5,004,598, and 5,349,030. These polymers have a large water-loving hydrophilic portion (the polyacrylic acid portion) and a smaller oil-loving hydrophobic portion (which can be derived from a long carbon chain acrylate ester). Representative higher alkyl acrylic esters are decycl acrylate, lauryl acrylate, stearyl acrylate, behenyl acrylate and melissyl acrylate, and the corresponding methacrylates. It should be understood that more than one carboxylic monomer and more than one acrylate ester or vinyl ester or ether or styrenic can be used in the monomer charge. The polymers can be dispersed in water and neutralized with base to thicken the aqueous composition, form a gel, or emulsify or suspend a deliverable. Useful polymers are sold as Carbopol® 1342 and 1382 and Pemulen® TR-1, TR-2, 1621, and 1622, all available from Noveon. The carboxyl containing polymers are prepared from monomers containing at least one activated vinyl group and a carboxyl group, and would include copolymers of polymerizable carboxylic monomers with acrylate esters, acrylamides, alkylated acrylamides, olefins, vinyl esters, vinyl ethers, or styrenics. The carboxyl containing polymers have molecular weights greater than about 500 to as high as several billion, or more, usually greater than about 10,000 to 900,000 or more.

Also useful are interpolymers of hydrophobically modified monomers and steric stabilizing polymeric surface active agents having at least one hydrophilic moiety and at least one hydrophobic moiety or a linear block or random comb configuration or mixtures thereof. Examples of steric stabilizers which can be used are Hypermer®, which is a poly(12-hydroxystearic acid) polymer, available from Imperial Chemical Industries Inc. and Pecosil®, which is a methyl-3-polyethoxypropyl siloxane-ω-phosphate polymer, available from Phoenix Chemical, Somerville, N.J. These are taught by U.S. Pat. Nos. 4,203,877 and 5,349,030, the disclosures of which are incorporated herein by reference.

The polymers can be crosslinked in a manner known in the art by including, in the monomer charge, a suitable crosslinker in amount of about 0.1 to 4%, preferably 0.2 to 1% by weight based on the combined weight of the carboxylic monomer and the comonomer(s). The crosslinker is selected from polymerizable monomers which contain a polymerizable vinyl group and at least one other polymerizable group. Polymerization of the carboxyl-containing monomers is usually carried out in a catalyzed, free radical polymerization process, usually in inert diluents, as is known in the art.

Other polycarboxylic acid polymer compositions which can be employed include, for example, crosslinked copolymers of acrylates, (meth)acrylic acid, maleic anhydride, and various combinations thereof. Commercial polymers are available from Rheox Inc., Highstown, N.J. (such as Rheolate® 5000 polymer), 3 V Sigma, Bergamo, Italy (such as Stabelyn® 30 polymer, which is an acrylic acid/vinyl ester copolymer, or Polygel® and Synthalen® polymers, which are crosslinked acrylic acid polymers and copolymers), Noveon (such as Carbopol 674 (lightly crosslinked polyacrylate polymer), Carbopol 676 (highly crosslinked polyacrylate polymer), Carbopol EP-1 thickener, which is a acrylic emulsion thickener), or Rohm and Haas (such as Acrysol® ICS-1 and Aculyn® 22 thickeners, which are hydrophobically modified alkali-soluble acrylic polymer emulsions and Aculyn® 44 thickener, which is a hydrophobically modified nonionic polyol). Preferred are the Carbopol® and Pemulen® polymers, generally. The choice of the specific polymer to be employed will depend upon the desired rheology of the composition, and the identity of other compositional ingredients.

Clay thickeners comprise, for example, colloid-forming clays, for example, such as smectite and/or attapulgite types. The clay materials can be described as expandable layered clays, i.e., aluminosilicates and magnesium silicates. The term “expandable” as used to describe the instant clays relates to the ability of the layered clay structure to be swollen, or expanded, on contact with water. The expandable clays used herein are those materials classified geologically as smectites (or montmorillonite) and attapulgites (or polygorskites).

Smectites are three-layered clays. There are two distinct classes of smectite-type clays. In the first, aluminum oxide is present in the silicate crystal lattice; in the second class of smectites, magnesium oxide is present in the silicate crystal lattice. The general formulas of these smectites are Al₂(Si₂O₅)₂(OH)₂ and Mg₃(Si₂O₅)(OH)₂, for the aluminum and magnesium oxide type clays, respectively. It is to be recognized that the range of the water of hydration in the above formulas may vary with the processing to which the clay has been subjected.

Commercially available clays include, for example, montmorillonite, bentonite, volchonskoite, nontronite, beidellite, hectorite, saponite, sauconite and vermiculite. The clays herein are available under various trade names such as Gelwhite GP, Gelwhite H, Mineral Colloid BP, and Laponite from Southern Clay Products, Inc., Texas; and Van Gel 0 from R. T. Vanderbilt. Gelwhite H—NF has a typical chemical analysis of SiO₂ 66.5%; Al₂O₃ 14.7%; MgO 3.2%; Fe₂O₃ 0.8%; CaO 2.2%; Na₂O 3.3%; K₂O 0.1%; TiO₂ 0.2%. Gelwhite L-NF has a typical chemical analysis of SiO₂ 66.5%; Al₂O₃ 14.7%; MgO. 3.2%; Fe₂O₃ 0.8%; CaO 2.2%; Na₂O 3.3%; K₂O 0.1%; TiO₂ 0.2%. Gelwhite GP has a typical chemical analysis of SiO₂ 66.5%; Al₂O₃ 14.7%; MgO 3.2%; Fe₂O₃ 0.8%; CaO 2.2%; Na₂O 3.3%; K₂O 0.1%; TiO₂ 0.2%. Mineral Colloid BP has a typical chemical analysis of SiO₂ 62.9%; Al₂O3 17.1%; MgO 2.4%; Fe₂O₃4.8%; CaO 0.7%; Na₂O 2.1%; K₂O 0.2%; TiO₂ 0.1%.

A second type of expandable clay material useful in the instant invention is classified geologically as attapulgite (polygorskite). Attapulgites are magnesium-rich clays having principles of superposition of tetrahedral and octahedral unit cell elements different from the smectites. A typical attapulgite analyses yields 55.02% SiO₂; 10.24% Al₂O₃; 3.53% Fe₂O₃; 10.45% MgO; 0.47% K₂O; 9.73% H₂O removed at 150° C.; 10.13% H₂O removed at higher temperatures. Like the smectites, attapulgite clays are commercially available. For example, such clays are marketed under the tradename Attagel, i.e. Attagel 40, Attagel 50 and Attagel 150 from Engelhard Minerals & Chemicals Corporation.

The preferred clay thickeners comprise the inorganic, colloid forming clays of smectite and/or attapulgite types. Preferred clays include products from Vanderbilt Chemical Company such as VanGel O.

When present the thickener may be present in any amount which is found to be effective in achieving a desired degree of thickening, and when present the amount of thickener is advantageously in the range of from about 0.001 to 10 wt % based on the total weight of the composition of which it forms a part.

It is to be understood however that in many particularly preferred embodiments such a thickener constituent is necessarily excluded from the inventive compositions as sufficient viscosity is imparted by the judicious selection of the remaining constituents, particularly by the judicious selection of the surfactant constituents included in the compositions taught herein.

It is also contemplated that one or more oxidizing constituents may be included in the light duty dishwashing detergent compositions described herein.

The compositions are aqueous in nature, and comprises as the balance of the composition water in to order to provide to 100% by weight of the compositions of the invention. The water may be tap water, but is preferably distilled and is most preferably deionized water. If the water is tap water, it is preferably substantially free of any undesirable impurities such as organics or inorganics, especially mineral salts which are present in hard water which may thus undesirably interfere with the operation of the constituents present in the aqueous compositions according to the invention.

Preferred compositions of the invention are concentrated compositions which include a minimum of 40% wt., preferably a minimum of 45% wt. of non-aqueous constituents. Such provides a concentrated composition with a relatively low water content. The inventive compositions may take the form a viscous pourable liquid, or take the form a paste or gel, the former being only slightly or slowly pourable at room temperature (approx. 20° C.), the latter being substantially non-pourable at room temperature. Alternately a gel can be also described a a self-supporting mass, that is to say, when removed from a container a body of gelled material does not flow in any substantial amount, in contrast to a paste which is not self-supporting and which will flow, as further opposed to a liquid which is readily flowable at room temperature. The preferred compositions may also be produced in forms which exhibit thixotropic flow characteristics, particularly at room temperature.

The compositions of the invention are expected to be stable liquid, paste or gel compositions which do not undesirably degrade when subjected to an elevated temperature over an extended period of time. More specifically, the inventive compositions do not suffer precipitation or phase separation when a sample composition is subjected to an accelerated aging testing at 120° F., for a four-week test period. As is known to the art, such a test is a harsh test, and a useful indicator of the long term shelf stability of the tested sample composition.

According to one preferred embodiment of the invention there is provided a light duty dishwashing liquid detergent composition which comprises (but preferably consists of, or consists essentially of):
15-30% wt. of an anionic surfactant constituent which includes necessarily at least one of each: an alkyl ether sulfate surfactant or salt form thereof in conjunction with an alkyl sulfate or salt form thereof, preferably wherein the respective weight ratio of alkyl ether sulfate or salt form thereof to alkyl sulfate or salt form thereof is in the range of at least 1.85:1 to about 20:1;
1-20% wt of a surfactant constituent based on a polysaccharide, preferably one or more alkyl polyglycosides, preferably wherein the respective weight ratios of the total amount of the anionic surfactant constituent to the total amount of the alkyl polyglycosides is maintained as respective weight ratios in the range of about 1.35:1 to 5:1;
1-10% wt of a betaine surfactant constituent;
1-10% wt of one or more non-ionic surfactants particularly one or more alcohol ethoxylates;
optionally but preferably an organic solvent constituent;
optionally but where necessary, an acid constituent;
optionally one or more further constituents which are directed to improving the aesthetic or functional features of the inventive compositions; and,
water,

such that the final compositions are in the pH range of pH 5-7.5 and further wherein, the total amount of the non-aqueous constituents present in the composition comprise at least 40% by weight of the total weight of the light duty dishwashing detergent composition.

The inventive light duty dishwashing detergent compositions may be used for the manual washing of dishes and tableware but it is to be understood that the inventive compositions may also finds use in other areas as well including but not limited to: hard surface cleaning compositions, laundry pre spotter composition, detergent compositions used in the cleaning of floors, cabinetry, and other hard surfaces which may be present. Additionally the inventive light duty dishwashing detergent compositions taught herein may be used as hand wash detergent soaps and/or for use as cleaning compositions for fibrous substrates such as carpets, rugs, mats, and the like. Thus while the primary benefit of the light duty dishwashing compositions according to the present invention find use in the cleaning of dishes and tableware, is to be understood that this is a preferred use and that use in other areas known for both light duty dishwashing detergent compositions as well as in other areas may also benefit from the use of the present inventive composition.

Preferably the compositions are produced utilizing a temperature controlled vessel provided with a low-shear mixing apparatus.

Advantageously the compositions are produced in accordance with the following protocol. A major proportion of the water is supplied to the interior of a jacketed mixing vessel and the temperature of the water is maintained at about 18-25° C. A low shear mixer, such as a wide-bladed paddle mixer is supplied and operated at a speed of 20-50 rpm. Next, any organic solvents are added under mixing, followed by an acid constituent and mixing continued until a homogenous mixture was achieved. Thereafter any anhydrous surfactants are added under stirring, followed by the remaining surfactants except for the alkyl ether sulfate surfactant which is held in reserve. If necessary a surfactant may be first fluidified by heating it until it is rendered fluid prior to addition to the mixing vessel. One such surfactant which benefits from a preheating step is the glycoside surfactant. Thereafter the preservative and colorants may be added at this time, or alternately may be added at a later time if deemed desirably. Stirring continues while the temperature of the mixing vessel is elevated to about 55-70° C., and until a homogenous mixture is attained. Therafter the alkyl ether sulfate surfactant is provided to the vessel, an optionally the rotational speed of the mixer is decreased somewhat, say to 2-40 rpm. Ideally the rotational speed of the mixer is sufficient to ensure the blending of the composition while minimizing the entrainment of air bubbles which may be particularly difficult to remove from the composition especially when produced in a pasty or gel form. Optionally the fragrance and any further optional constituents and the balance of water are then added, and mixing continues at the decreased rate while the vessel is allowed to cool, which may be hastened by providing a cooling stream of water to the jacket of the mixing vessel so to reduce the temperature of the composition to between about 18-25° C.

The following examples below illustrate exemplary formulations as well as preferred embodiments of the invention. It is to be understood that these examples are provided by way of illustration only and that further useful formulations falling within the scope of the present invention and the claims may be readily produced by one skilled in the art without deviating from the scope and spirit of the invention.

### EXAMPLES

To demonstrate the compositions according to the invention, various formulations were prepared having the constituents which are indicated on Tables 1 and 1A below wherein the amounts given are the weight percent of each respective chemical compound or constituent which are to be considered as being provided as “100% wt. active” unless otherwise indicated on Table 1, 1A or 2 such as is the case with ‘proprietary’ compositions, e.g., fragrances, whose specific constituents are known only to their supplier.

Preparation of the formulations were performed in a routine manner, which was generally in accordance with the following protocol. To a large glass beaker placed on a magnetic stirrer apparatus was added less than the total amount, or was added the total amount of deionized water. The temperature of the water, as well as that of the remaining constituents was approximately room temperature (≅68° F., ≅20° C.) The stirrer apparatus was activated, and to the water was added measured amounts of each of the constituents. While order of addition of the constituents is not believed to be important, generally the surfactants were added to the stirring water and allowed to become well dispersed prior to the addition of the remaining constituents. Certain of the surfactants may be preheated in order to fluidify them prior to addition to the beaker in order to ensure that they would be well dispersed. After the addition of the final constituent, the contents of the beaker were allowed to stir for a period of 5 to 30 minutes to ensure homogeneous mixing and the production of a uniform formulation. Each of the formulations produced was observed to be shelf stable for period of several weeks.

TABLE 1

| | E1 | E2 | E3 | E4 | E5 | E6 | E7 | E8 | E9 | E10 |
|---|---|---|---|---|---|---|---|---|---|---|
| (A) sodium lauryl ether sulfate | — | — | — | — | — | — | — | — | — | — |
| (B) sodium lauryl ether sulfate | 14.70 | 21.00 | — | — | — | — | — | — | — | — |
| (C) sodium lauryl ether sulfate | — | — | 19.03 | 19.03 | 14.70 | 22.40 | 22.40 | 22.40 | 22.40 | 22.40 |
| (D) sodium lauryl sulfate | — | — | — | — | — | — | — | — | — | — |
| (E) sodium lauryl sulfate | 4.32 | 3.24 | 3.60 | 3.60 | 4.32 | 1.67 | 1.67 | 1.35 | 1.35 | 1.35 |
| (F) cocoamidopropyl dimethyl | 3.50 | 4.50 | 3.45 | 3.45 | 3.45 | 3.00 | 3.00 | 3.00 | 3.00 | 3.00 |
| betaine | | | | | | | | | | |
| (G) lauryl glycoside | 12.50 | 12.50 | 12.50 | 12.50 | 12.50 | 12.50 | 12.50 | 12.50 | 12.50 | 12.50 |
| (H) alcohol ethoxylate | — | — | 15.00 | 12.00 | — | 5.00 | 5.00 | 7.50 | — | — |
| (I) alcohol ethoxylate | — | — | — | 3.00 | — | 10.00 | 10.00 | 7.50 | 15.00 | 15.00 |
| (J) alcohol ethoxylate | — | — | — | — | — | — | — | — | — | — |
| (K) alkanolamide | 15.00 | — | — | — | 15.00 | — | — | — | — | — |
| (L) propylene glycol | 8.00 | 5.00 | 8.00 | 8.00 | 8.00 | 10.00 | 7.00 | 7.00 | 1.00 | 1.00 |
| (M) citric acid | 1.32 | 1.50 | 0.25 | 0.25 | 1.34 | 0.25 | 0.25 | 0.50 | 0.50 | 0.50 |
| (N) preservative | 0.20 | 0.20 | 0.20 | 0.20 | 0.20 | 0.20 | 0.20 | 0.20 | 0.20 | 0.20 |
| (O) preservative | 0.05 | 0.05 | 0.05 | 0.05 | 0.05 | 0.05 | 0.05 | 0.05 | 0.05 | 0.05 |
| (P) colorant | 0.0012 | 0.0012 | 0.0012 | 0.0012 | 0.0012 | 0.0012 | 0.0012 | 0.0012 | 0.0012 | 0.0012 |
| (Q) fragrance | 0.30 | 0.10 | 0.30 | 0.30 | 0.30 | 0.30 | 0.30 | 0.30 | 0.30 | 0.30 |
| deionized water | q.s. | q.s. | q.s. | q.s. | q.s. | q.s. | q.s. | q.s. | q.s. | q.s. |
| pH | 6.61 | 6.10 | 6.10 | 6.10 | 6.61 | 6.56 | 6.65 | 5.43 | -- | 5.34 |
| % wt. total solids | 59.34 | 47.74 | 61.83 | 61.58 | 59.31 | 64.82 | 61.82 | 61.75 | 55.75 | 55.75 |
| Appearance: | paste | paste | viscous | paste | viscous | viscous | viscous | viscous | paste | viscous |
| | | | liquid | | liquid | liquid | liquid | liquid | | liquid |
| | E11 | E12 | E13 | E14 | E15 | E16 | E17 | E18 | E19 | E20 |
| (A) sodium lauryl ether sulfate | — | — | — | — | — | — | — | — | — | — |
| (B) sodium lauryl ether sulfate | — | — | — | — | — | — | — | — | — | — |
| (C) sodium lauryl ether sulfate | 22.40 | 22.40 | 20.43 | 15.40 | 15.40 | 14.00 | 23.80 | 23.80 | 23.80 | 23.80 |
| (D) sodium lauryl sulfate | — | — | 10.00 | 8.00 | 8.00 | — | — | — | — | — |
| (E) sodium lauryl sulfate | 1.35 | 1.35 | — | — | — | 12.02 | 9.45 | 9.45 | 9.45 | 9.45 |
| (F) cocoamidopropyl dimethyl | 3.00 | 3.00 | 3.60 | 6.00 | 6.00 | 3.00 | — | — | — | — |
| betaine | | | | | | | | | | |
| (G) lauryl glycoside | 12.50 | 12.50 | 15.00 | 10.00 | 10.00 | 10.00 | 7.00 | 7.00 | 7.00 | 7.00 |
| (H) alcohol ethoxylate | 15.00 | 15.00 | 5.00 | 3.60 | 3.80 | — | — | — | — | — |
| (I) alcohol ethoxylate | — | — | — | — | — | — | — | — | — | — |
| (J) alcohol ethoxylate | — | — | — | — | — | 4.00 | 3.50 | 3.50 | 3.50 | 3.50 |
| (K) alkanolamide | — | — | — | — | — | — | — | — | — | — |
| (L) propylene glycol | 5.00 | 7.00 | 12.00 | 12.00 | 10.00 | — | — | 3.70 | 1.70 | 5.70 |
| (M) citric acid | 0.50 | 0.50 | 0.50 | 0.35 | 0.35 | 0.50 | 0.50 | 0.50 | 0.50 | 0.50 |
| (N) preservative | 0.20 | 0.20 | 0.20 | 0.20 | 0.20 | 0.20 | 0.20 | 0.20 | 0.20 | 0.20 |
| (O) preservative | 0.05 | 0.05 | 0.05 | 0.05 | 0.05 | 0.05 | 0.05 | 0.05 | 0.05 | 0.05 |
| (P) colorant | 0.0012 | 0.0012 | 0.0012 | 0.0012 | 0.0010 | 0.0010 | 0.0010 | 0.0010 | 0.0010 | 0.0010 |
| (Q) fragrance | 0.30 | 0.30 | 0.10 | 0.10 | 0.30 | 0.30 | 0.30 | 0.30 | 0.30 | 0.30 |
| deionized water | q.s. | q.s. | q.s. | q.s. | q.s. | q.s. | q.s. | q.s. | q.s. | q.s. |
| pH | 6.47 | 6.56 | 6.56 | 6.63 | 6-7 | 5-6 | 5-6 | 5-6 | 5-6 | 5-6 |
| % wt. total solids | 59.75 | 61.75 | 66.53 | 55.35 | 53.20 | 43.52 | 44.25 | 47.95 | 45.95 | 49.95 |
| Appearance: | viscous | viscous | viscous | viscous | viscous | viscous | viscous | viscous | viscous | viscous |
| | liquid | liquid | liquid | liquid | liquid | liquid | liquid | liquid | liquid | liquid |

| | E21 | E22 | E23 | E23 | E24 | E25 | E26 |
|---|---|---|---|---|---|---|---|
| (A) sodium lauryl ether sulfate | — | — | — | — | — | — | — |
| (B) sodium lauryl ether sulfate | — | — | — | — | — | — | — |
| (C) sodium lauryl ether sulfate | 23.80 | 23.80 | 23.80 | 23.80 | 15.40 | 19.60 | 23.80 |
| (D) sodium lauryl sulfate | — | — | — | — | 8.00 | 8.64 | — |
| (E) sodium lauryl sulfate | 9.45 | 9.45 | 9.45 | 9.45 | — | — | 9.10 |
| (F) cocoamidopropyl dimethyl | — | — | — | — | 6.00 | 1.50 | — |
| betaine | | | | | | | |
| (G) lauryl glycoside | 7.00 | 7.00 | 7.00 | 7.00 | 10.00 | 10.00 | 7.00 |
| (H) alcohol ethoxylate | — | — | — | — | — | — | 3.80 |
| (I) alcohol ethoxylate | — | — | — | — | — | 4.00 | — |
| (J) alcohol ethoxylate | 3.50 | 3.50 | 3.50 | 3.50 | 3.80 | — | — |
| (K) alkanolamide | — | — | — | — | — | — | — |
| (L) propylene glycol | 9.70 | 4.70 | 3.70 | 2.70 | 10.00 | 9.20 | 2.00 |
| (M) citric acid | 0.50 | 0.50 | 0.50 | 0.50 | 0.35 | 0.50 | 0.50 |
| (N) preservative | 0.20 | 0.20 | 0.20 | 0.20 | 0.20 | 0.20 | 0.20 |
| (O) preservative | 0.05 | 0.05 | 0.05 | 0.05 | 0.05 | 0.05 | 0.05 |
| (P) colorant | 0.0010 | 0.0010 | 0.0010 | 0.0010 | 0.0010 | 0.0010 | 0.0010 |
| (Q) fragrance | 0.30 | 0.30 | 0.30 | 0.30 | 0.30 | 0.30 | 0.30 |
| deionized water | q.s. | q.s. | q.s. | q.s. | q.s. | q.s. | q.s. |
| pH | 5-6 | 5-6 | 5-6 | 5-6 | 6.60 | 6.73 | 6.76 |
| % wt. total solids | 53.95 | 48.95 | 47.95 | 46.95 | 53.55 | 53.44 | 46.2 |
| Appearance: | viscous | viscous | viscous | viscous | viscous | viscous | viscous |
| | liquid | liquid | liquid | liquid | liquid | liquid | liquid |

| | E27 | E28 | E29 | E30 | E31 | E32 | E33 | E34 | E35 |
|---|---|---|---|---|---|---|---|---|---|
| (A) sodium lauryl ether sulfate | — | — | — | — | — | — | — | — | — |
| (B) sodium lauryl ether sulfate | — | — | — | — | — | — | — | — | — |
| (C) sodium lauryl ether sulfate | 21.00 | 21.00 | 23.80 | 21.00 | 21.00 | 21.00 | 19.95 | 19.95 | 21.00 |
| (D) sodium lauryl sulfate | — | — | — | — | — | — | — | — | — |
| (E) sodium lauryl sulfate | — | — | 6.75 | — | — | — | — | — | — |
| (U) sodium lauryl sulfate | 7.00 | 7.00 | — | 7.00 | 7.00 | 7.00 | 6.00 | 6.00 | 7.00 |
| (F) cocoamidopropyl dimethyl | 2.40 | 2.40 | 2.40 | 2.40 | 2.40 | 2.40 | 2.40 | 2.40 | 2.40 |
| betaine | | | | | | | | | |
| (G) lauryl glycoside | 10.00 | 10.00 | 7.00 | 8.00 | — | 8.00 | 10.00 | 10.00 | 10.00 |
| (T) C₈-C₁₆ alkyl glycoside | — | — | — | — | 8.00 | — | — | — | — |
| (H) alcohol ethoxylate | 3.40 | 3.40 | 3.40 | 2.40 | 2.40 | 2.40 | 1.40 | 0.40 | 3.40 |
| (I) alcohol ethoxylate | — | — | — | — | — | — | — | — | — |
| (J) alcohol ethoxylate | — | — | — | — | — | — | — | — | — |
| (K) alkanolamide | — | — | — | — | — | — | — | — | — |
| (S) alkanolamide | — | — | — | 3.00 | 3.00 | 3.00 | 4.00 | 5.00 | — |
| (L) propylene glycol | 2.00 | 5.00 | 2.00 | 9.80 | 4.80 | 4.80 | 3.30 | 2.30 | 2.80 |
| (M) citric acid | 0.50 | 0.50 | 0.50 | 0.50 | 0.50 | 0.50 | 0.50 | 0.50 | 0.50 |
| (N) preservative | 0.30 | 0.30 | 0.30 | 0.30 | 0.30 | 0.30 | 0.30 | 0.30 | 0.30 |
| (O) preservative | 0.10 | 0.10 | 0.10 | 0.10 | 0.10 | 0.10 | 0.10 | 0.10 | 0.10 |
| (P) colorant | 0.10 | 0.10 | 0.10 | 0.10 | 0.10 | 0.10 | 0.10 | 0.10 | 0.10 |
| (Q) fragrance | 0.30 | 0.30 | 0.30 | 0.30 | 0.30 | 0.30 | 0.30 | 0.30 | 0.30 |
| deionized water | q.s. | q.s. | q.s. | q.s. | q.s. | q.s. | q.s. | q.s. | q.s. |
| pH | 6.76 | 5-6 | 5-6 | 5-6 | 5-6 | 5-6 | 5-6 | 5-6 | 5-6 |
| % wt. total solids | 46.30 | 49.30 | 45.85 | 54.10 | 49.10 | 49.10 | 47.55 | 46.55 | 47.10 |
| Appearance: | gel | viscous | viscous | viscous | viscous | viscous | viscous | viscous | viscous |
| | | liquid | liquid | liquid | liquid | liquid | liquid | liquid | liquid, |
| | | | | | | | | | gel after |
| | | | | | | | | | 2 days |

| | E36 | E37 | E38 | E39 | E40 | E41 | E42 | E43 | E44 | E45 |
|---|---|---|---|---|---|---|---|---|---|---|
| (A) sodium lauryl ether sulfate | — | — | — | — | — | — | — | — | — | — |
| (B) sodium lauryl ether sulfate | — | — | — | — | — | — | — | — | — | — |
| (C) sodium lauryl ether sulfate | 21.00 | 21.00 | 21.00 | 23.80 | 23.80 | 23.80 | 13.30 | 19.60 | 19.60 | 21.10 |
| (D) sodium lauryl sulfate | — | — | — | — | — | — | — | — | — | — |
| (E) sodium lauryl sulfate | — | — | — | 8.10 | 8.10 | 8.10 | 8.10 | 8.10 | 8.10 | 5.94 |
| (U) sodium lauryl sulfate | 7.00 | 7.00 | 7.00 | — | — | — | — | — | — | — |
| (F) cocoamidopropyl dimethyl | 2.40 | 2.40 | 2.40 | 2.40 | 2.40 | 2.40 | 2.40 | 2.40 | 2.40 | 2.40 |
| betaine | | | | | | | | | | |
| (G) lauryl glycoside | 10.00 | 10.00 | 10.00 | 7.00 | 7.00 | 7.00 | 10.25 | 6.50 | 6.50 | 10.00 |
| (T) C₈-C₁₆ alkyl glycoside | — | — | — | — | — | — | — | — | — | — |
| (H) alcohol ethoxylate | 3.40 | 3.40 | 3.40 | 2.50 | 2.40 | 3.00 | 3.50 | — | — | 3.00 |
| (I) alcohol ethoxylate | — | — | — | — | — | — | — | — | — | — |
| (J) alcohol ethoxylate | — | — | — | — | — | — | — | — | — | — |
| (X) alcohol ethoxylate | — | — | — | — | — | — | — | 3.00 | 3.00 | |
| (K) alkanolamide | — | — | — | — | — | — | — | — | — | — |
| (S) alkanolamide | — | — | — | — | — | — | — | — | — | — |
| (V) alkanolamide | — | — | — | — | — | 3.00 | — | — | 4.00 | 4.00 |
| (W) alkanolamide | — | — | — | — | — | — | 6.00 | 4.00 | — | — |
| (L) propylene glycol | 2.50 | 4.80 | 5.80 | — | — | — | — | — | — | 4.20 |
| (M) citric acid | 0.50 | 0.50 | 0.50 | 0.50 | 0.50 | 0.50 | 0.50 | 0.50 | 0.50 | 0.50 |
| (N) preservative | 0.30 | 0.30 | 0.30 | 0.30 | 0.30 | 0.30 | 0.30 | 0.30 | 0.30 | 0.30 |
| (O) preservative | 0.10 | 0.10 | 0.10 | 0.10 | 0.10 | 0.10 | 0.10 | 0.10 | 0.10 | 0.10 |
| (P) colorant | 0.10 | 0.10 | 0.10 | 0.10 | 0.10 | 0.10 | 0.10 | 0.10 | 0.10 | 0.10 |
| (Q) fragrance | 0.30 | 0.30 | 0.30 | 0.30 | 0.30 | 0.30 | 0.30 | 0.30 | 0.30 | 0.30 |
| deionized water | q.s. | q.s. | q.s. | q.s. | q.s. | q.s. | q.s. | q.s. | q.s. | q.s. |
| pH | 5-6 | 5-6 | 5-6 | 5-6 | 5-6 | 5-6 | 5-6 | 5-6 | 5-6 | 5-6 |
| % wt. total solids | 46.80 | 49.10 | 50.10 | 44.30 | 44.20 | 47.80 | 44.05 | 44.10 | 44.10 | 47.14 |
| Appearance: | viscous | gel | gel | gel | gel | gel | gel | viscous | gel | gel |
| | liquid, | | | | | | | liquid | | |
| | gel after | | | | | | | | | |
| | 2 days | | | | | | | | | |

| | E46 | E47 | E48 | E49 | E50 |
|---|---|---|---|---|---|
| (A) sodium lauryl ether sulfate | — | — | — | — | — |
| (B) sodium lauryl ether sulfate | — | — | — | — | — |
| (C) sodium lauryl ether sulfate | 21.00 | 21.00 | 20.30 | 22.40 | 15.40 |
| (D) sodium lauryl sulfate | — | — | — | — | — |
| (E) sodium lauryl sulfate | — | — | 8.10 | 8.10 | — |
| (U) sodium lauryl sulfate | 7.00 | 7.00 | — | — | 8.00 |
| (F) cocoamidopropyl dimethyl | 2.40 | 2.40 | 2.40 | 2.40 | 2.40 |
| betaine | | | | | |
| (G) lauryl glycoside | 10.00 | 10.00 | 7.00 | 7.00 | 10.00 |
| (T) C₈-C₁₆ alkyl glycoside | — | — | — | — | — |
| (H) alcohol ethoxylate | — | 3.40 | — | — | 3.40 |
| (I) alcohol ethoxylate | — | — | — | — | — |
| (J) alcohol ethoxylate | — | — | — | — | — |
| (X) alcohol ethoxylate | 3.40 | — | 3.00 | 3.00 | |
| (K) alkanolamide | — | — | — | — | — |
| (S) alkanolamide | — | — | — | — | 4.00 |
| (V) alkanolamide | — | — | | — | — |
| (W) alkanolamide | — | — | 4.00 | 2.00 | — |
| (L) propylene glycol | 4.80 | 6.80 | 5.80 | — | 10.00 |
| (M) citric acid | 0.50 | 0.50 | 0.50 | 0.50 | 0.35 |
| (N) preservative | 0.30 | 0.30 | 0.30 | 0.30 | 0.30 |
| (O) preservative | 0.10 | 0.10 | 0.10 | 0.10 | 0.10 |
| (P) colorant | 0.10 | 0.10 | 0.10 | 0.10 | 0.10 |
| (Q) fragrance | 0.30 | 0.30 | 0.30 | 0.30 | 0.30 |
| deionized water | q.s. | q.s. | q.s. | q.s. | q.s. |
| pH | 5-6 | 5-6 | 5-6 | 5-6 | 6-7 |
| % wt. total solids | 49.10 | 51.10 | 51.10 | 45.40 | 53.55 |
| Appearance: | paste/gel | paste/gel | paste/gel | paste/gel | paste/gel |

Viscosity measured using Brookfield Type III viscometer, #1 spindle, 30 rpm at room temperature

TABLE 1A

| | E51 |
|---|---|
| (A) sodium lauryl ether sulfate | — |
| (B) sodium lauryl ether sulfate | — |
| (C) sodium lauryl ether sulfate | 15.40 |
| (D) sodium lauryl sulfate | 8.00 |
| (E) sodium lauryl sulfate | — |
| (F) cocoamidopropyl dimethyl betaine | 6.00 |
| (G) lauryl glycoside | 10.00 |
| (H) alcohol ethoxylate | 3.80 |
| (I) alcohol ethoxylate | — |
| (J) alcohol ethoxylate | — |
| (K) alkanolamide | — |
| (L) propylene glycol | — |
| (M) citric acid | 0.35 |
| (N) preservative | 0.20 |
| (O) preservative | 0.05 |
| (P) colorant | 0.001 |
| (Q) fragrance | 0.30 |
| (R) thickener | 6.00 |
| deionized water | q.s. |
| pH | 6-7 |
| % wt. total solids | — |
| Appearance: | viscous |
| | liquid |

The formulation of Table 1A illustrates an exemplary formulation according to the invention which includes an added water dispersible thickener.

In the foregoing compositions the reported amount of the non-aqueous constituents were based on the total amount of the non-aqueous constituents and additionally also excluded the preservatives, colorants and fragrance constituents which were provided. As the exact constitution of the preservatives, colorants and fragrance constituents were unknown, their amounts were not included in this calculation of “% wt. of the total solids” of each composition.

The identity of the individual constituents indicated on Tables 1, 1A above, and exemplary commercial sources for these materials are described on the following Table 2.

TABLE 2

| | |
|---|---|
| (A) sodium lauryl ether sulfate | DACLOR 70-2-23 AL, avg. 3 EO (70% wt. actives) |
| (B) sodium lauryl ether sulfate | DACLOR 70-1-23AL, avg. 1 EO, branched structure |
| | (67% wt. actives) |
| (C) sodium lauryl ether sulfate | DACLOR 70-3-23AL, avg. 3 EO, branched structure |
| | (70% wt. actives) |
| (D) sodium lauryl sulfate | STEPANOL WA-100 NF/USP, anhydrous composition |
| | (100% wt. actives) |
| (E) sodium lauryl sulfate | DACPON 27-23-AL, branched configuration (27% wt. |
| | actives) |
| (F) cocoamidopropyl dimethyl betaine | EMPIGEN BS/FA (30% wt. actives) |
| (G) lauryl glycoside | GLUCOPON 600 CSUP (50% wt. actives) |
| (H) alcohol ethoxylate | NEODOL 91-6, C9-C11 alcohol ethoxylate, avg. 6 EO |
| | (100% wt. actives) |
| (I) alcohol ethoxylate | NEODOL 91-8, C9-C11 alcohol ethoxylate, avg. 8 EO |
| | (100% wt. actives) |
| (J) alcohol ethoxylate | NEODOL 25-3, C12-C15. avg. 3 EO (100% wt. |
| | actives) |
| (K) alkanolamide | MONAMID 150ADY (100% wt. actives) |
| (L) propylene glycol | propylene glycol, laboratory grade (95-100% wt. |
| | actives) |
| (M) citric acid | aqueous citric acid composition (50% wt. actives) |
| (N) preservative | ACTICIDE FN, containing 65.1% wt. |
| | tetrahydroxymethylglyoxal diureaide |
| (O) preservative | ACTICIDE MBS, containing 2.5% wt. bensisothiazoline |
| | and 2.5% wt. methylisothiazoline |
| (P) colorant | proprietary composition |
| (Q) fragrance | proprietary composition |
| (R) thickener | NATROSOL, a water dispersible |
| | hydroxyethylcellulose thickener, supplied anhydrous |
| | (100% wt. actives) |
| (S) alkanolamide | MONAMID CMA-S, coconut monoethanolamide |
| | (100% wt. actives) |
| (T) C₈-C₁₆ alkyl glycoside | GLUCOPON 650 CSUP (50% wt. actives) |
| (U) sodium lauryl sulfate | STEPANOL ME, anhydrous composition (100% wt. |
| | actives) |
| (V) alkanolamide | MONAMID-S, stearic monoethanolamide (100% wt. |
| | actives) |
| (W) alkanolamide | ALKAMIDE C-212, coconut monoethanolamide |
| | (100% wt. actives) |
| deionized water | deionized water |

The degree of foaming as well as the substantivity of the foam produced by a pair of sample compositions according to E12 and E13 were evaluated in accordance with the following general protocol. A sample of a commercial product, FAIRY (ex. Procter & Gamble Co.(UK)) was also used as a comparative composition.

In each test, to 100 milliliters of room temperature water was added a sufficient amount of a sample composition in order to form a 0.05% wt. dilution, which mixture was then provided to a 250 milliliter graduated cylinder. The cylinder was then stoppered with a laboratory rubber stopper and shaken vigorously for 30 seconds in order to generate foam. Immediately afterwards, the graduated cylinder was placed upon a laboratory table top and allowed to rest, and the height of the foam, measured as the difference in the height between the bottom of the foam layer formed at the surface of the liquid at the bottom of the graduated cylinder and the upper most margin of the foam was determined and recorded. Subsequently, a ten gram sample of cold pressed virgin olive oil was then pipetted into the composition within the graduated cylinder. Again, the cylinder was stoppered, and again manually shaken for 30 seconds and then again, placed upon a laboratory table top and in a like manner, the foam height was determined and recorded. This test determined the durability of the foam, and in particularly the height of the foam following the addition of the hydrophobic olive oil to the initial mixture of the product in water.

The results of this test as performed on the E12 and E13 formulations, as contrasted to the commercial product are indicated on the following table:

TABLE 3

| | Foam Height (millilitres) |
|---|---|
| E12 | 77 ml |
| E13 | 77 ml |
| FAIRY | 45 ml |

As is evident from the foregoing, the inventive compositions far exceeded the foam height performance of the commercially available produced used as a comparative composition.

The aqueous dispersability of sample compositions were determined in accordance with the following general protocol.

A test jig was made by providing a normal laboratory standing have a vertical post of at least 1 meter in height. At a height one meter from the base of the laboratory stand was provided a conventional laboratory test tube clamp which was affixed to the vertical post. The laboratory test tube clamp contained in its jaws a funnel having its narrow end facing downward toward the base of the laboratory stand.

In according to the test, a container which included 5 liters of room temperature deionized water was prepared for use. Next, into a dry, large stainless steel mixing bowl was provided into the interior bottom of which was pipetted a 2.5 gram aliquot of a sample composition. The mixing bowl is than placed adjacent and abutting the laboratory stand such that the pooled sample composition within the bowl was directly vertically beneath the open end of the funnel. Next, the 5 liters of water was poured through the funnel at a uniform rate thereby providing a controlled fluid delivery rate as well as a specific vertical drop distance to the water impinging upon the sample composition in the bowl. The turbulence of the water insured thorough mixing of the water with the sample composition, and the formation of a dishwashing liquor. The degree and height of foam formed immediately subsequent to mixing was observed and recorded.

The formulations tested and used in cleaning of standardized soiled dishes as outlined below all exhibited excellent aqueous dispersability.

The cleaning efficacy of sample compositions as well as one comparative composition was evaluated by determination of the number of uniformly soiled dinner plates which could be cleaned by the dishwashing liquor until no visible foam was present in the bowl. The test protocol used was closely based on that published under “Recommendation for the Quality Assessment of the Cleaning Performance of Hand Dishwashing Detergents”, SÖFW-Journal, 128. Jarhgang 5-2002, which is a known to the art. The general steps of this test protocol, and the specific steps used in the evaluation are as follows.

First a test soil was made from the following constituents, which were provided in the indicated weight percentages:

| Test Soil | % wt. |
|---|---|
| beef tallow | 1.2 |
| vegetable fat | 1.2 |
| margarine (80% fat content) | 1.2 |
| butter (“sweet creamy” grade) | 1.2 |
| lard | 1.2 |
| crème fraiche (30% fat content) | 1.2 |
| sunflower oil | 1.2 |
| olive oil | 1.2 |
| skim milk powder (1% fat content) | 9.6 |
| wheat flour (Type 405) | 28.8 |
| water | 51.8 |

The test soil was made by providing the bulk of the water at room temperature to a large laboratory beaker supplied with a magnetic stirring rod. Then under stirring measured amounts of the other constituents were added in the following general sequence: fats (which if solid at room temperature, were heated to their melting point in order to liquefy them); followed by the powdered materials, and stirring continued until the test soil was well mixed. Thereafter the stirring rod was removed, and the container was placed overnight into a freezer in order to cool the composition. The following day, and on any subsequent day that the balance of the cleaning test were to be performed, the container was removed and the contents allowed to thaw and allowed to come to room temperature prior to being further used.

Prior to testing of cleaning efficacy of any composition, a series of standardized soiled plates were prepared according to the following general protocol.

To each of a series of machine dishwashed and dried ceramic or glass dinner plates was pipetted 6.7 g of the thawed test soil described above which was applied to the middle of each plate and allowed to spread without interference. The dinner plates were then stacked and ready for use in a subsequent cleaning test.

Cleaning testing was performed immediately subsequently to an evaluation of the aqueous dispersability of sample compositions as noted above.

Each of a number of plates was removed from the stack of standardized soiled plates and each was sequentially immersed for several seconds by hand into the dishwashing liquor, and while in this dishwashing liquor, the bristled end of a conventional dishwashing hand brush was manually applied under constant pressure to the soiled face of each plate and the bristles were moved in a circular motion five times on this side of the plate, and then the bristles were moved in a circular motion two times on the reverse or back side of the plate. Thereafter the treated dish was removed and stacked and allowed to dry. The cleaning of plated continued until it was visually observed that all foam on the surface of the dishwashing liquor had dissipated or dispersed, although a minor amount of foam could be visible at the edges of the surface of the dishwashing liquor. The number of plates thus cleaned was recorded.

The foregoing test was performed for compositions according to E3, E5, E6, E12, E13; the results of these tests are reported on the following Table 4:

TABLE 4

| | Plates Cleaned |
|---|---|
| E3 | 43 |
| E5 | 33 |
| E6 | 41 |
| E12 | 40 |
| E13 | 43 |

The foregoing test was also repeated five times for compositions according to E14 as well as for a commercially available product, FAIRY which had been previously identified. The results of these tests are reported on the following Table 5:

TABLE 5

| | E14 - plates cleaned | FAIRY - plates cleaned |
|---|---|---|
| test series 1 | 38 | 33 |
| test series 2 | 42 | 39 |
| test series 3 | 39 | 35 |
| test series 4 | 39 | 34 |
| test series 5 | 42 | 36 |

As is evident from the foregoing, the composition of E14 provided better cleaning results than the FAIRY product per the test protocol indicated herein.

1. A light duty dishwashing detergent composition which comprises:
an anionic surfactant constituent which includes necessarily at least one of each: a alkyl ether sulfate surfactant or salt form thereof in conjunction with an alkyl sulfate or salt form thereof;
a surfactant constituent based on a polysaccharide, preferably one or more alkyl polyglycosides;
optionally a betaine surfactant constituent;
optionally one or more non-ionic surfactants particularly one or more alcohol ethoxylates;
optionally an organic solvent constituent;
optionally an acid constituent;
optionally one or more further constituents directed to improving the aesthetic or functional features of the inventive compositions; and,
water,
wherein the final compositions are in the pH range of pH 5-7.5 and further
wherein, the total amount of the non-aqueous constituents present in the composition comprise at least 40% by weight of the total weight of the light duty dishwashing detergent composition.

2. A composition according to claim 1 wherein anionic surfactant constituent excludes sulfonate based surfactants.

3. A composition according to claim 1 wherein the anionic surfactant constituent includes both an alkyl ether sulfate or salt form thereof and an alkyl sulfate or salt form thereof wherein said are present in is in a respective weight ratio of at least 1.1:1 to about 20:1.

4. A composition according to claim 3 wherein the weight ratio of alkyl ether sulfate to alkyl sulfate is in the range of 1.1:1 to 5:1.

5. A composition according to claim 1
wherein the respective weight ratio of the anionic surfactant constituent to the surfactant constituent based on a polysaccharide is in the range of at least about 1.35:1.

6. A composition according to claim 1
wherein the respective weight ratio of the anionic surfactant constituent to the surfactant constituent based on a polysaccharide is in the range of 2:1 to 5:1.

7. A composition according to claim 1 comprising one or more non-ionic surfactants.

8. A composition according to claim 7 wherein the composition comprises one or more non-ionic alcohol ethoxylates.

9. A composition according to claim 1 wherein the composition comprises one or more organic solvents.

10. A composition according to claim 1 wherein the composition comprises one or more acids.

11. A composition according to claim 1 comprising:
15-30% wt. of an anionic surfactant constituent which includes necessarily at least one of each: an alkyl ether sulfate surfactant or salt form thereof in conjunction with an alkyl sulfate or salt form thereof, wherein the respective weight ratio of alkyl ether sulfate or salt form thereof to alkyl sulfate or salt form thereof is in the range of at least 1.85:1 to about 20:1;
1-20% wt of a surfactant constituent based on a polysaccharide, selected from one or more alkyl polyglycosides, wherein the respective weight ratios of the total amount of the anionic surfactant constituent to the total amount of the alkyl polyglycosides is maintained as respective weight ratios in the range of about 1.35:1 to 5:1;
1-10% wt of a betaine surfactant constituent;
1-10% wt of one or more non-ionic surfactants selected from one or more alcohol ethoxylates;
optionally an organic solvent constituent;
optionally an acid constituent;
optionally one or more further constituents which are directed to improving the aesthetic or functional features of the inventive compositions; and,
water,
such that the final compositions are in the pH range of pH 5-7.5 and further wherein, the total amount of the non-aqueous constituents present in the composition comprise at least 40% by weight of the total weight of the light duty dishwashing detergent composition.

12. A composition according to claim 1, wherein the composition is in the form of a gel.

13. A composition according to claim 1, wherein the composition is in the form of a paste.

14. A composition according claim 1, wherein the composition is in the form of a pourable viscous liquid.

15. A composition according to claim 11 wherein the composition includes an organic solvent constituent.

16. A composition according to claim 11 wherein the composition includes an acid constituent.
